(19) United States
(12) Patent Application Publication
(10) Pub. No.: US 2012/0270130 A1
(43) Pub. Date: Oct. 25, 2012

(54) METHOD FOR SUPPLYING POWER FROM A FUEL CELL TAKING SULPHUR OXIDE POLLUTION INTO ACCOUNT, AND POWER SUPPLY DEVICE

(75) Inventors: Olivier Lemaire, Les Abrets (FR); Nicolas Bardi, Miribel-Les-Echelles (FR); Benoit Barthe, Chindrieux (FR); Alejandro Franco, Eybens (FR)

(73) Assignee: COMMISSARIAT A L'ENERGIE ATOMIQUE ET AUX ENERGIES ALTERNATIVES, Paris (FR)

(21) Appl. No.: 13/498,216

(22) PCT Filed: Sep. 24, 2010
(86) PCT No.: PCT/FR2010/000639

§ 371 Date: Mar. 26, 2012

(30) Foreign Application Priority Data
Sep. 25, 2009 (FR) 09 04592

(51) Int. Cl. H01M 8/04

(52) U.S. Cl. 429/442

(57) ABSTRACT

The method for supplying power from a fuel cell detects a sulphur oxide in the oxidising gas of the cell and decreases the operating temperature of the cell when the quantity of sulphur oxide detected is greater than a predetermined threshold. The temperature decrease can vary according to the degradation rate of the performances.

### BACKGROUND OF THE INVENTION

The invention relates to a method for supplying power from a fuel cell comprising an oxidising gas.

The invention also relates to a power supply device comprising a fuel cell and means for controlling the operating temperature of the cell, the cell comprising an oxidising gas.

### STATE OF THE ART

Fuel cells are electrochemical systems that enable chemical energy to be converted into electricity. For Proton Exchange Membrane Fuel Cells (PEMFC), the chemical energy is in the form of gaseous hydrogen. The fuel cell is divided into two compartments separated by a proton exchange membrane. One of the compartments is supplied with hydrogen, called fuel gas, and the other compartment is supplied with oxygen or air, called oxidising gas. On the anode, the oxidation reaction of hydrogen produces protons and electrons. The protons pass through the membrane whereas the electrons have to pass through an external electric circuit to reach the cathode. The reduction reaction of oxygen takes place on the cathode in the presence of protons and electrons.

The core of the cell, also called membrane-electrode assembly (MEA), is formed by catalytic layers and by the separating membrane. The catalytic layers are the location of the oxidation and reduction reactions in the cell. Gas diffusion layers are arranged on each side of the MEA to ensure electric conduction, homogeneous gas inlet and removal of the water produced by the reaction and of the non-consumed gases.

Pollution of the fuel and oxidising gases is one of the main factors responsible for degradation of the performances of a PEM fuel cell. The impurities contained in hydrogen (fuel gas) are for example carbon oxides CO and CO₂, sulphurated compounds (H₂S in particular) and ammoniac NH₃. These impurities originate in particular from the hydrogen fabrication method. Pollutants of air or oxygen (oxidising gas) are for example nitrogen oxides NO_{X}, sulphur oxides SO_{X} and carbon oxides CO_{X}. These pollutants generally originate from automobile vehicle exhausts, and industrial and military sites.

These contaminants can penetrate into the chemical reaction areas of the cell and fix themselves on the catalytic sites of the anode and of the cathode. The catalytic sites are then blocked and no longer participate in the oxidation and reduction processes. The contaminants further modify the structure and the properties of the core of the cell, for example modifying its hydrophobic or hydrophilic nature.

Degradation of the performances of the cell is therefore mainly due to reduction in the catalytic activity, to the heat loss following the increase of the resistance of the cell components and to the mass transport losses following variations of the structure. Among the oxidising gas pollutants set out above, sulphur oxides (SO_{X}), in particular sulphur dioxide SO₂, are particularly harmful and greatly impair the performances of the cell.

Different electrochemical methods are used to regenerate the performances of a fuel cell after a pollution episode by a sulphurated compound. These methods consist in applying an electric current or an electric pulse to each of the contaminated electrodes in order to remove the impurities from their surfaces. Another method consists in imposing a voltage which varies in cyclic manner between −1.5V and 1.5V. These regeneration techniques provide a satisfactory level of performance. Such techniques do however require the cell to be powered-off. Although it can be for a brief period, shutdown of the cell is detrimental to the device supplied by the cell. It is therefore preferable to minimize the number of these operations by limiting degradation of the cell during pollution.

The article “A review of PEM hydrogen fuel cell contamination : Impacts, mechanisms, and mitigation” (Cheng and al., Journal of Power Sources, 165, 739-756, 2007) suggests that a temperature increase is beneficial for operation of a fuel cell. On the one hand, the temperature increase enables the impact of the fuel gas pollutants, in particular carbon monoxide CO, to be limited. On the other hand, the speeds of the hydrogen oxidation reaction and of the oxygen reduction reaction are increased and hydraulic management is facilitated.

None of the proposed solutions however enables degradation of the performances to be limited during a oxidising gas pollution phase by sulphur oxides.

### OBJECT OF THE INVENTION

The object of the invention is to provide a method for supplying power from a fuel cell that is simple and easy to implement, and that enables the performances of the cell to be preserved even during pollution.

More particularly, the object of the invention is to provide a method for supplying power enabling the degradation rate of the performances to be reduced when pollution by sulphur oxides takes place.

According to the invention, this object is achieved by the fact that the method successively comprises the following steps: detecting sulphur oxide in the oxidising gas, and decreasing the operating temperature of the cell when the quantity of sulphur oxide detected is greater than a predetermined threshold.

It is a further object of the invention to provide a power supply device.

This object is achieved by the fact that the power supply device comprises a device for detecting sulphur oxide in the oxidising gas and that the means for controlling comprise means for decreasing the temperature when the quantity of sulphur oxide detected is greater than a predetermined threshold.

### BRIEF DESCRIPTION OF THE DRAWINGS

Other advantages and features will become more clearly apparent from the following description of particular embodiments of the invention given for non-restrictive example purposes only and represented in the appended drawings, in which:

FIG. 1 represents a power supply device according to the invention.

FIG. 2 represents the variations of performances of a cell with time, versus the temperature.

FIG. 3 schematically represents the variations of the temperature and of the performances of a cell with time, in a method for supplying power according to the invention.

FIG. 4 schematically represents the variations of the temperature and of the performances of a cell with time, in a variant of the method for supplying power according to the invention.

### DESCRIPTION OF PARTICULAR EMBODIMENTS

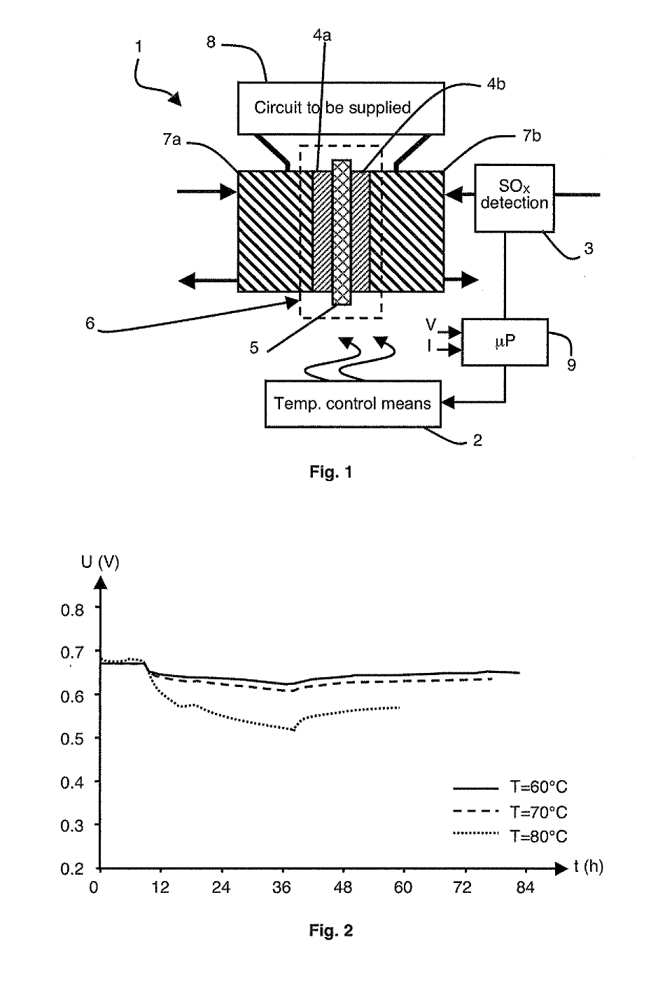

FIG. 1 represents a power supply device. The device comprises a proton exchange membrane fuel cell (PEMFC) 1, means 2 for controlling the operating temperature of the cell and a device 3 for detecting sulphur oxide in the oxidising gas. The PEMFC comprises anodic and cathodic electrodes, respectively 4a and 4b, and a separating membrane 5 made from polymer placed between electrodes 4a and 4b. The membrane-electrode assembly (MEA) 6 constitutes the core of the cell. The electrodes are arranged on gas diffusion layers 7a and 7b connected to an electric circuit 8 to be supplied.

Each gas diffusion layer (7a, 7b) comprises a gas inlet and an outlet for the excess gas and the reaction products. The inlets-outlets are represented by horizontal arrows, respectively on the left for the fuel gas and on the right for the oxidising gas in FIG. 1.

In the particular embodiment represented in FIG. 1, the device advantageously comprises an electronic control circuit 9, for example a microprocessor, enabling the degradation rate of the performances of the cell to be determined, in particular from the measured values of voltage (V) and current (I). Control circuit 9 is also connected to the output of detection device 3 so as to control the temperature control means 2.

To limit degradation of the cell during a pollution phase by a sulphur oxide SO_{X}, the operating temperature of the cell is decreased when the quantity of sulphur oxide detected is greater than a predetermined threshold. This decrease in the operating temperature enables the drop-off of the performances of the cell to be slowed down. When detection device 3 indicates the presence of sulphur oxide in the oxidising gas, sulphur dioxide SO₂ for example, control means 2 reduce the temperature of the cell. Temperature control means 2 for example comprise heating rugs, a ventilation system and a heat transfer fluid. Cooling can then be performed by stopping the electric power supply of the heating rugs associated with regular ventilation of the cell or by rapid lowering of the temperature of the heat transfer fluid. A temperature decrease is for example about 10° C. to 20° C.

FIG. 2 illustrates an example of operation of the cell represented in FIG. 1. The operating conditions of this cell are the following:
Charging of the electrodes with catalyst, platinum for example, is about 0.5 mg/cm².
The polymer membrane is preferably made from Nafion® (DuPont™) and has a thickness of about 50 μm.
The moisture content of the reactive gases on the anode and on the cathode is about 60%.
The current density of the cell is about 0.6 A/cm².

The curve plots of FIG. 2 represent the voltage U at the terminals of this cell versus time for different temperatures (60° C., 70° C. and 80° C.). Voltage U decreases between 10 h and 40 h, corresponding to a pollution phase, and increases after 40 h of operation, corresponding to a pollutant-free phase. The concentration of polluting gas SO₂ in the air is about 1.5 ppm (parts per million).

At an operating temperature of 80° C. (dotted line plot), voltage U drops rapidly from 0.68 V to 0.54 V whereas at 70° C. (dashed line plot), the voltage only drops from 0.68 V to 0.63 V. The voltage decrease is even more reduced at a temperature of 60° C., as represented by the unbroken line plot.

The voltage at the terminals of the cell can be one of the physical parameters representative of degradation of the performances during a pollution phase. The degradation rate of the performances then corresponds to the speed of decrease of the voltage. In FIG. 2, this rate is on average equal to 5.17 mV/h at an operating temperature of 80° C., 2 mV/h at 70° C. and 1.5 mV/h at 60 ° C. The degradation rate of the performances is thus at least divided by two if the temperature is decreased from 80° C. to 70° C. The rate is reduced even further if the temperature is reduced to 60° C.

The method for supplying power therefore successively comprises a step of detecting sulphur oxide in the oxidising gas (by detection device 3) and a step of decreasing the operating temperature of the cell (by temperature control means 2) when the quantity of sulphur oxide detected is greater than a predetermined threshold. During the detection step, the gas detector can measure the quantity of pollutant gas in a certain volume of oxidising gas and thus determine the pollutant concentration, for example 1 ppm. This concentration can be used as criterion for controlling the temperature of the cell.

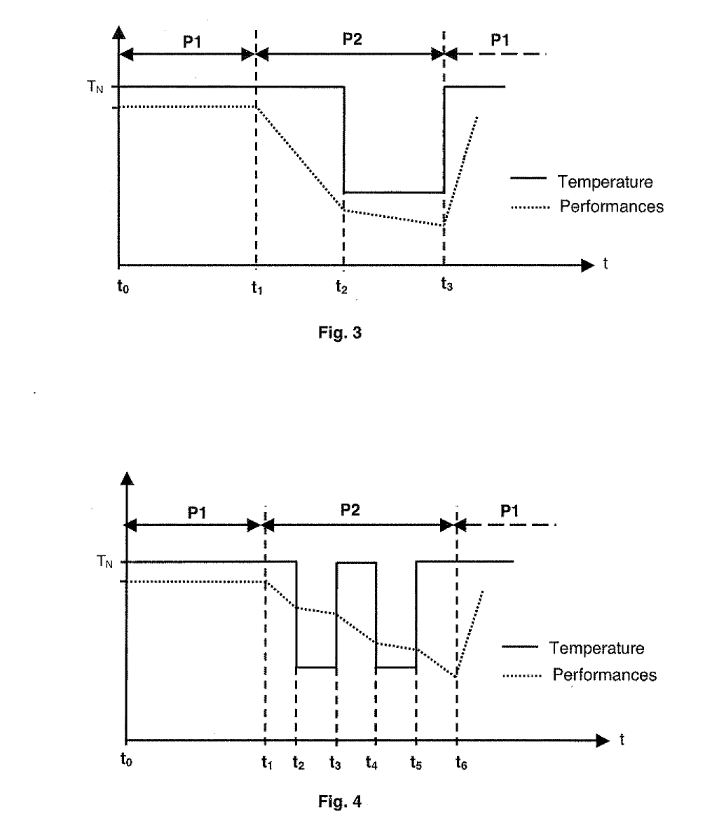

FIG. 3 schematically represents the variations of the performances and of the temperature with time during pollutant-free phases P1 and a pollution phase P2. Between instants t₀ and t₁, the cell is in a pollutant-free operating phase (phase P1). The temperature is at a maximum nominal value T_{N} and the performances are maximal and constant. Between instants t₁ and t₃ (phase P2), a sulphur oxide is present in the oxidising gas. Up to instant t₂, the temperature is kept at its initial value and the performances decrease rapidly. The decrease rate of the performances, corresponding to the slope of the associated curve, is in fact high. Detection device 3 detects the presence of sulphur oxide and order a temperature decrease to temperature control means 2. The temperature decreases, for example by 10° C., as from instant t₂. The performances continue to decrease but to a greatly reduced speed. The slope decreases which means that the degradation rate of the performances is reduced. At instant t₀, the cell is again operating without pollutant, the temperature is increased to its nominal value T_{N} and the performances of the cell revert to their initial level.

This method for supplying power differs from the regeneration techniques cited in the foregoing to achieve the initial performances of a cell after a pollution phase. Indeed, this involves slowing down degradation of the cell during a pollution phase in order to retrieve, at the end of the pollution phase, performances close to the performances before pollution. It can be noted in FIG. 2 that operation at decreased temperature enables a better return to initial performances.

In an alternative embodiment represented in FIG. 4, the temperature decrease during a pollution phase P2 can be performed in the form of cycles. The decrease rate (slope of the performances curve) is thus reduced in transient manner during certain time intervals. For example the temperature is reduced between instants t₂ and t₃, and then between t₄ and t₅ and increased between times t₃ and t₄, and then between t₅ and t₆. This alternative embodiment also allows a good return to performances after pollution. This variant further presents the advantage of scheduling returns to normal temperature and of detecting whether the decrease rate of performances always has the same value.

The method advantageously comprises a step of calculating the degradation rate of the cell performances. Control circuit 9 for example determines the voltage decrease at the terminals of the cell during the pollution phase. If the degradation rate is high, which is the sign of a large pollutant concentration, the operating temperature can be further decreased in order to reduce this rate. Decrease in the operating temperature is then a function not only of the presence of the pollutant but also of the degradation rate of the performances. The higher this rate is, the greater the temperature decrease is. The temperature decrease is preferably comprised between 10° C. and 20° C. Advantageously, this decrease will be comprised between 5% and 70% of the value of the nominal operating temperature.

The method for supplying power when pollution of the oxidising gas takes place is applicable even if the fuel gas is also polluted, by NH₃ or CO for example. As described in the foregoing, a temperature increase is advantageous in the case of pollution of the fuel gas. A decrease of the temperature therefore reduces the performances of the cell with respect to pollution of the fuel gas and to the reaction kinetics. The temperature decrease on the other hand slows down degradation of the cell due to s sulphur oxide in the oxidising gas. The benefits of this slowing-down in degradation are nevertheless greater than the loss of performances due to the temperature decrease. Sulphur oxides are in fact very harmful for operation of the cell. It will therefore always be advantageous to reduce the temperature when pollution by these oxides takes place.

1-7. (canceled)

8. A method for supplying power from a fuel cell comprising an oxidising gas, successively comprising the following steps:
detecting sulphur oxide in the oxidising gas, and
decreasing an operating temperature of the fuel cell when a quantity of sulphur oxide detected is greater than a predetermined threshold.

9. The method according to claim 8, further comprising calculating a degradation rate of performances of the fuel cell.

10. The method according to claim 9, wherein the decrease in the operating temperature of the fuel cell is a function of the degradation rate of performances of the fuel cell.

11. The method according to claim 8, wherein the decrease in the operating temperature of the fuel cell is performed in the form of cycles.

12. The method according to claim 8, wherein the sulphur oxide is sulphur dioxide.

13. The method according to claim 8, wherein the decrease in the operating temperature of the fuel cell is comprised between 5% and 70% of a nominal operating temperature of the fuel cell.

14. A power supply device comprising:
a fuel cell comprising a oxidising gas;
a detection device for detecting sulphur oxide in the oxidising gas;
a temperature control device for decreasing a operating temperature of the fuel cell when the quantity of sulphur oxide detected is greater than a predetermined threshold.
